(19) United States
(12) Patent Application Publication
(10) Pub. No.: US 2014/0329053 A1
(43) Pub. Date: Nov. 6, 2014

(54) STRETCH LAMINATE

(71) Applicants: Georg BALDAUF, Laer (DE); Marcus SCHOENBECK, Versmold (DE)

(72) Inventors: Georg BALDAUF, Laer (DE); Marcus SCHOENBECK, Versmold (DE)

(21) Appl. No.: 14/268,364

(22) Filed: May 2, 2014

(30) Foreign Application Priority Data
May 3, 2013 (EP) 13166530.9

(51) Int. Cl. B32B 3/26

(52) U.S. Cl. CPC B32B 3/263
USPC 428/152

(57) ABSTRACT

A stretch laminate has at least one cover web, an elastomeric film attached to the cover web and having two opposite faces, and a skin on at least one of the faces. An adhesive at an anchor zone between the skin and the cover web bonds the skin to the cover web at the anchor zone, leaving a stretch zone free of adhesive adjacent the anchor zone. The skin having wrinkles in the anchor zone but not in the stretch zone.

### FIELD OF THE INVENTION

The present invention relates to a stretch laminate.

### BACKGROUND OF THE INVENTION

Stretch laminates form one group of materials commonly used for the production of hygiene articles such as diapers. As the name suggests, these materials are actually composites of individual components that are laminated together, by an adhesive for example. A typical stretch laminate will attempt to combine one or more layers of cover material with one or more layers or strands of an elastomeric material. A stretch laminate may hereafter also be referred to as “elastic laminate” or simply “laminate.”

Complications arise in that stretch laminates are is notoriously difficult and expensive to manufacture. Considerable effort has gone into proposing new types of stretch laminates and new methods of making stretch laminates. In particular, a considerable number of patents discuss the difficulties of making these laminates, and the significant and extensive steps that must be undertaken to prepare these laminates. Thus, there is a continuing need to provide new stretch laminates, new methods of making better performing and/or cheaper stretch laminates, and new absorbent articles that are made of such stretch laminates.

The terms “activated” and “preactivated” refer to a process of mechanically deforming a material in order to increase the extensibility of at least a portion of the material. A material may be activated or preactivated by, for example, incrementally stretching the material in at least one direction.

The terms “adhesively bonded” or “adhesively laminated” refer to a laminate where an adhesive is used to bond an elastomeric material to at least one cover web.

The term “attached” refers to elements connected or united by fastening, adhering, bonding, or by any other method suitable for connecting the elements together and to their constituent materials. Many suitable methods of attaching elements together are well known, including adhesive bonding, pressure bonding, thermal bonding, ultrasonic bonding, mechanical fastening, etc. Such attachment methods may be used to attach elements together over a particular area either continuously or intermittently.

The term “provided” is used to mean that an element(s) is formed (joined and positioned) in a particular place or position as a unitary structure with other elements or as a separate element joined to another element.

The term “stretchable” refers to the property of a material, whereby when a biasing force is applied to the material, the material can be extended to an elongated length of at least 110% of its original relaxed length (i.e., can extend 10%), without a rupture or breakage that renders the material unusable for its intended purpose. A material that does not meet this definition is considered unstretchable. In some embodiments, a stretchable material may be able to be extended to an elongated length of 125% or more of its original relaxed length without rupture or breakage that renders the material unusable for its intended purpose. A stretchable material may or may not exhibit recovery after application of a biasing force.

Throughout the present disclosure, a stretchable material is considered to be “elastically stretchable” if, when a biasing force is applied to the material, it can be extended to an elongated length of at least 110% of its original relaxed length (i.e., can extend 10%), without rupture or breakage which renders the material unusable for its intended purpose, and when the force is removed from the material, the material recovers at least 40% of its elongation. In various examples, when the force is removed from an elastically stretchable material, the material may recover at least 60%, or at least 80%, of its elongation.

The term “joined” refers to configurations where an element is directly secured to another element by attaching the element directly to the other element, and configurations where an element is indirectly secured to another element by attaching the element to intermediate member(s) which in turn are attached to the other element.

The term “lateral” or “transverse” refers to a direction running at a 90° angle to the longitudinal direction and includes directions within ±45° of the lateral direction.

The term “longitudinal” refers to a direction running parallel to the maximum linear dimension of the article and includes directions within ±45° of the longitudinal direction.

The term “recovery” refers to ability of a material to return to its original size after it has been stretched.

The “strain” or “percent strain” of a material is calculated by subtracting the original length from the stretched length, then dividing the result by the original length and multiplying by 100. The percent strain is described by the equation below:

Percent Strain=% Strain=Strain=100*[(Lₛ−L₀)/L₀]

where L₀ is the original length of the stretch laminate (or elastomeric film) in an arbitrary direction at the beginning of the stretch step, and Lₛ is the length of the stretched laminate (or elastomeric film) at the end of the stretch step. A sample stretched from an original length of 10 mm to a length of 30 mm results in a strain of 200%. Strain can be calculated in a length direction, a width direction, or any direction therebetween.

The “set” or “percent set” of a material is calculated by subtracting an original length from a final length, then dividing the result by the original length and multiplying by 100. The percent set is described by the equation below:

Percent Set=% Set=Set=100*[(L_{f}−L₀)/L₀]

where L₀ is an original length of the stretch laminate (or elastomeric film) in an arbitrary direction at the beginning of the stretch step, and L_{f} is a length of the relaxed stretch laminate (or elastomeric film) after it is relaxed from the stretch step. A sample is stretched from an original length of 10 mm to a length of 30 mm. Upon relaxing (removal of stress), the sample returns to 15 mm. This results in a set of 50%. Set can be calculated in a length direction, a width direction, or any direction there between.

The term “wrinkle” refers to a small fold, ridge or crease.

### OBJECTS OF THE INVENTION

It is therefore an object of the present invention to provide an improved stretch laminate.

Another object is the provision of such an improved stretch laminate that overcomes the above-given disadvantages.

### SUMMARY OF THE INVENTION

The stretch laminate according to the invention has at least one cover web and an elastomeric film attached to the cover web. The elastomeric film has two faces and a skin on at least one of the faces. In one embodiment, the elastomeric film may also be provided between a first cover web and a second cover web. The elastomeric film has a first skin on a first face closest to the first cover web and a second skin on a second face closest to the second cover web.

The stretch laminate has at least one anchor zone and at least one stretch zone, and the skin in the anchor zone has a plurality of wrinkles. These wrinkles may also be referred to as activation stripes.

In order to produce the laminate, elastic strips are laminated next to one another between nonwoven material webs. The nonwoven material webs are supplied without prestretching and joined to the strips. The laminate thus formed is then stretched transverse to the web direction in regions rendered elastic by the laminated strips, and after elastic relaxation is wound into a roll. Due to the stretching of the laminate, which is also referred to as mechanical activation, the elastic properties of the laminate transverse to the web direction of the material web (CD, “cross direction”) are improved.

According to a first embodiment of the method of making a laminate according to the invention, an elastic film is stretched transverse to the web direction and, after elastic relaxation, is cut into strips. The strips are laminated next to one another between nonwoven material webs supplied without prestretching and joined to the strips. Last, the laminate thus formed is stretched transverse to the web direction in regions rendered elastic by the laminated strips and, after elastic relaxation, is wound into a roll. Closure elements may be punched from the material that have an elastic center and less elastic ends.

Stretching the elastic film mechanically preactivates a component of the laminate and results in an improvement in the stretching behavior of the laminate. The preactivation of the elastic film has a positive effect on the stretching force profile of the laminate and contributes to the laminate being easily stretchable over a large stretching area while greatly increasing the stretching resistance for a yield strength determined by the preactivation of the elastic film, the stretching resistance being readily determined as the yield strength upon subsequent use of the laminate. In addition, the elastic relaxation behavior of the laminate after strain relief may be improved by using a preactivated elastic film. However, the preactivation of the elastic film does not replace the mechanical activation of the laminate, but instead cooperates with it synergistically. In the preactivation of the elastic film, the film is preferably stretched essentially uniformly over its entire width. In contrast, the stretching of the laminate for mechanical activation is locally limited to the regions of the laminate that are already elastic due to the laminated strips that are preactivated according to the invention. Due to the stretching of the laminate, fibers of the nonwoven layers are irreversibly stretched in the elastic regions of the laminate, and bonding of the nonwoven in the elastic regions is reduced due to fiber tears and fiber rearrangements. This is accompanied by a renewed mechanical effect on the material of the elastic strips, as well as a mechanical effect on localized bonds between the film face and adjacent fibers. Areas of the laminate between the elastic regions are not altered by stretching the laminate and retain the properties of the nonwoven.

For purposes of the preactivation, the elastic film is preferably stretched transversely by 100% to 500%. These numerical values refer to the change in length of the film transverse to the web longitudinal direction relative to the starting width of the film. The value of 100% means that the film in the stretched state has a width that is twice the starting width of the film. The stretching is not fully reversible. As the result of inelastic portions of the film, after its elastic relaxation the film has a slightly greater width than prior to the stretching. The width subsequent to the elastic relaxation may be approximately 10% to 30% greater than the starting width of the elastic film prior to transverse stretching.

For preactivation of the elastic film, i.e., for the transverse stretching of the elastic film prior to its further processing, a stretching roller system composed of intermeshing profile rollers is preferably used. The profile rollers may in particular be composed of multiple disks that are combined into packets, the disks preferably being arranged equidistantly for uniform stretching transversely of the web.

After preactivation, the elastic film is cut into strips. The strips are guided over deflectors and may be supplied as parallel strips to a lamination unit where the strips are laminated between nonwoven webs supplied on the upper and lower faces. The elastic strips are advantageously spaced from one another. The spacing between the strips may be set by positioning the deflectors. The nonwoven webs are directly joined together in the gaps between the elastic strips. It is also within the scope of the invention that the areas between the elastic strips are reinforced by co-laminated reinforcing strips. Elastic and inelastic regions may thus be formed in the laminate.

For the mechanical activation, the laminate may be guided through a nip between two profile rollers each including at least two disk packets each having a plurality of disks on a common axis. The laminate is stretched in places by intermeshing disk packets of the two profile rollers. In roller sections between the disk packets, the profile rollers form a gap through which the laminate is guided essentially without transverse stretching.

Relative to the overall width of the laminated strips, the maximum transverse stretching of the laminate for the mechanical activation corresponds to the value by which the elastic film is stretched for purposes of preactivation. In other words, in the area of the laminated strips, the maximum stretching of the laminate is as great as that of the elastic film during its preactivation. The transverse stretching of the laminate for the mechanical activation (relative to the overall width of the laminated strips) is preferably 50% to 90% of the value by which the film is stretched for purposes of preactivation.

A film composed of a polyolefin elastomer is preferably used as the elastic film. The preactivation of the elastic film is particularly effective when an elastic film based on polyolefin elastomers is used.

A single-layer film or a multilayer film having an elastomeric core layer composed of styrene-isoprene-styrene (SIS) block copolymers, styrenebutadiene-styrene (SBS) block copolymers, styrene-ethylene/butylene-styrene (SEBS) block copolymers, polyurethanes, ethylene copolymers, or polyether block amides may also be used as elastic film.

The nonwoven from which the cover webs of the laminate are made has fibers made of stretchable polymers that have only slight elasticity compared to the polymer of the elastic film. The nonwoven may be composed of melt-blown fibers, staple fibers, or continuous fibers, the fibrous web formed from the fibers being mechanically, thermally, or chemically bonded. In particular, spun-lace nonwovens may also be used as cover webs.

In a second method of making a printed stretch laminate according to a preferred embodiment of the invention, the elastic film is printed with a motif made visible through the textile surface layer of the laminate before cutting the strips. Due to the fact that the elastic film is provided with the imprint, even while using the laminate that has been printed, correct alignment of the printed motif relative to the elastic region of the laminate is always ensured. The advantage therein lies in the fact that, when stretching the elastic strip, the printed image is evenly and reversibly stretched along with it. Furthermore, the printed motif is visible from the front side as well as from the back side of the laminate, for example, through a nonwoven textile surface layer, such that the laminate is optically equally attractive from the front as well as from the back. For example, the elastic film can be printed with a striped motif consisting of parallel, colored stripes extending in the direction of the web of the elastic film.

Known continuous printing methods can be used for printing the elastic film. Rotary printing processes are preferred that allow for printing the elastic film at high web speeds. The goal is web speeds of approximately 400 m/min. Gravure printing and flexography methods are advantageous processes, flexography being particularly preferred because it is possible to use one central cylinder for a plurality of color systems. Digital printing that transfers the printed image directly from a computer into a printing machine without the use of a static medium are not excluded. In particular, ink-jet printing methods are conceivable that generate a printed image by deflecting small ink drops.

The elastic film is preferably stretched transversely of the direction of the web before the printing process, then printed after elastic retraction, and subsequently cut into strips. The stretching of the elastic film constitutes a mechanical preactivation of a layer of the laminate and results in improved stretching behavior of the laminate. The preactivation of the elastic film has a positive effect on the expansion force and provides easy stretching action of the laminate over a large area and at an expansion limit that is determined by the preactivation of the elastic film and beyond which the expansion resistance increases strongly. The return behavior of the laminate after tension is removed can also be improved if the elastic film is preactivated by transverse stretching before laminating it into the laminate. Any preactivation of the elastic film cannot replace but can only supplement the mechanical activation of the laminate. Even when the elastic film is preactivated, it is still necessary for the laminate to be stretched transversely of the direction of the web in regions that are to be rendered elastic by laminated strips.

A preferred embodiment of the method according to the invention provides that the elastic film is stretched transversely of the web by more than 50% and has a width after reverse expansion that is greater than the starting width of the elastic film by 10% to 30% before it was stretched. The term “stretching” is used despite the fact that the expansion is not completely reversible but that some plastic deformation results in the film having a larger width following the reverse expansion. Later activation of the laminate essentially affects the structure of the textile cover webs. The transverse stretching of the preactivated elastic film, on the other hand, is for the most part reversible. The printed image that is applied to the preactivated elastic film thus does not undergo any further disadvantageous changes during subsequent activation of the laminate. Correspondingly, it is possible to improve the quality of the printed image on the elastic laminate if the elastic film is only printed following preactivation, during which the elastic film is expanded transversely and then released.

It is possible to use a stretch-rolling apparatus of profile rollers that mesh with each other for the stretching action of the elastic film and/or the laminate.

Preferably a polyolefin elastomer film is used as the elastic film. When using a polyolefin-elastomer-based elastic film, preactivation of the elastic film is especially advantageous.

In addition, it is also possible to use as an elastic film a single-layer or multilayer film having an elastomeric core layer made a material of styreneisoprene-styrene block copolymers (SIS), styrene-butadiene-styrene block copolymers (SBS), styrene-ethylene-butylene-styrene block copolymers (SEBS), polyurethanes, ethylene copolymers, or polyether block amides.

After preactivation and printing, the elastic film is cut into strips. The strips are guided across a deflector and can be supplied as parallel strips to a laminator where the strips are laminated between the textile cover webs. The elastic strips are positioned at a transverse spacing from each other. The transverse spacing between the strips can be adjusted by the position of the deflector. The cover webs are directly bonded to each other in the gaps between the elastic strips. It is within the scope of the invention to use reinforcement strips that are laminated between the elastic strips so as to reinforce the gaps between the elastic strips. It is thus possible to constitute elastic and inelastic regions inside the laminate.

### BRIEF DESCRIPTION OF THE DRAWINGS

FIG. 1A is a cross section through a first embodiment of a stretch laminate according to the present disclosure;

FIG. 1B is a cross section through a second embodiment of a stretch laminate according to the present disclosure;

FIG. 2 is a SEM photomicrograph showing a cross section through a portion of an elastomeric film that has not been preactivated;

FIG. 3 is a magnified version of the SEM photomicrograph of FIG. 2;

FIG. 4 is a SEM photomicrograph showing a cross section through a portion of a preactivated elastomeric film;

FIG. 5 is a magnified version of the SEM photomicrograph of FIG. 4;

FIG. 6 is a transmitted light photomicrograph of a top view of a portion of an elastomeric film that has not been preactivated;

FIG. 7 is a transmitted light photomicrograph of a top view of a portion of a preactivated elastomeric film;

FIG. 8 is a SEM photomicrograph showing a cross section through a portion of a stretch laminate that includes an elastomeric film that has not been preactivated;

FIG. 9 is a magnified version of the SEM photomicrograph of FIG. 8;

FIG. 10 is a SEM photomicrograph showing a cross section through a portion of a stretch laminate that includes an elastomeric film that has been preactivated;

FIG. 11 is a magnified version of the SEM photomicrograph of FIG. 10;

FIG. 12 is a schematic illustration of a first embodiment of a continuous process for making a stretch laminate according to the present disclosure;

FIG. 13 is a schematic illustration of a second embodiment of a continuous process for making a stretch laminate according to the present disclosure;

### SPECIFIC DESCRIPTION OF THE INVENTION

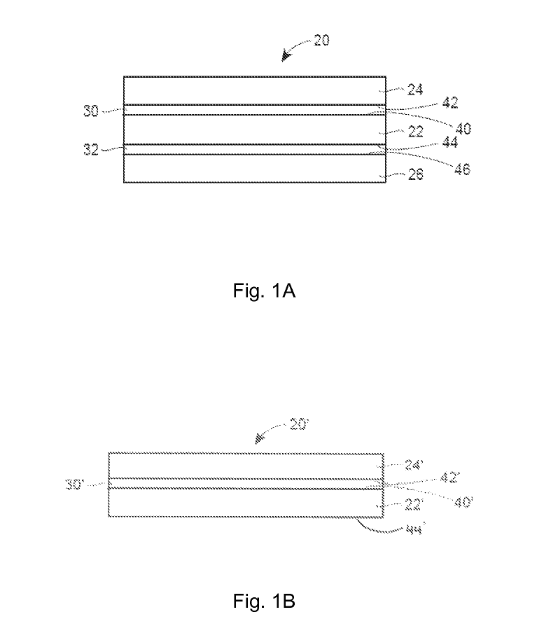

FIG. 1A illustrates an embodiment of a stretch laminate 20 according to the present disclosure. According to this embodiment, the laminate 20 may include three layers: an elastomeric film 22, a first cover web 24, and a second cover web 26. However, according to other embodiments (as shown in FIG. 1B), a the laminate 20′ may only include two layers: an elastomeric film 22′ and a cover web 24′. Although the following description will refer to the specific reference numbers in FIG. 1A, the prime versions of those numbers relating to the two layer embodiment of FIG. 1B are also intended to be considered by the reader. For example, when the description refers to “the elastomeric film 22 and the first cover web 24 of the stretch laminate 20”, it is intended that the reader also consider the same description for “the elastomeric film 22′ and cover web 24′ of stretch laminate 20′.”

The elastomeric film 22 and the cover webs 24 and 26 may be attached to each other. According to the invention, an adhesive 30, 32 is provided between the layers 22, 24, and 26. As will be recognized, the adhesive 30 may be initially provided either on a first face 40 of the elastomeric film 22 or a face 42 of the cover web 24, and the adhesive 32 may similarly be initially provided either on a second face 44 of the elastomeric film 22 or a face 46 of the cover web 26. As assembled, the adhesive 30 attaches the face 40 (and thus the elastomeric film 22) to the face 42 (and thus the cover web 24), and the adhesive 32 attaches the face 44 (and thus the elastomeric film 22) to face 46 (and thus the cover web 26).

While the layers 22, 24, and 26 appear to overlie each other completely, this need not be the case in all embodiments. For example, the cover webs 24 and 26 may extend beyond the elastomeric film 22, and may be attached one to the other where the layers 24, 26 extend beyond the elastomeric film 22; alternatively, the cover webs 24 and 26 may not extend to the limits of the elastomeric film 22. Also, while the adhesive 30, 32 appears as a continuous layer in FIGS. 1A and 1B, the adhesive may be applied as a continuous layer or in a discontinuous pattern (such as a pattern of lines, spirals, or spots). Accordingly, the bonding can be the full width of the stretch laminate 20 or a partial width of the laminate (for example intermittent or zone bonding).

The elastomeric film 22 of the stretch laminate 20 includes a single layer or multiple layer material that is elastically stretchable. The elastically stretchable material is may be between about 10 μm and about 100 μm, or between about 20 μm and about 60 μm, or between about 30 μm and about 50 μm, or in some embodiments, about 40 μm, in thickness. The elastically stretchable material may comprise an elastomeric polyolefin, and in some embodiments, a polyolefin (POE) blown film. Nonlimiting examples of useful elastically stretchable materials include propylene based homopolymers or co-polymers, or ethylene based homopolymers or co-polymers selected from the group consisting of: an elastic random poly(propylene/olefin) copolymer, an isotactic polypropylene containing stereoerrors, an isotactic/atactic polypropylene block copolymer, an isotactic polypropylene/random poly(propylene/olefin) copolymer block copolymer, a stereoblock elastomeric polypropylene, a syndiotactic polypropylene block poly(ethylene-co-propylene) block syndiotactic polypropylene tri-block copolymer, an isotactic polypropylene block region-irregular polypropylene block isotactic polypropylene tri-block copolymer, a polyethylene random (ethylene/olefin) copolymer block copolymer, a reactor blend polypropylene, a very low density polypropylene, a metallocene polypropylene, metallocene polyethylene, and combinations thereof. Additional nonlimiting examples of useful elastically stretchable materials include styreneisoprene-styrene block copolymers, styrene-butadiene-styrene block copolymers, styrene-ethylene-butylene-styrene block copolymers, polyurethanes, ethylene copolymers, polyether block amides, and combinations thereof.

The elastically stretchable material may comprise modifying resins. Such modifying resins useful herein include, but are not limited to, unhydrogenated C5 hydrocarbon resins or C9 hydrocarbon resins, partially and fully hydrogenated C5 is hydrocarbon resins or C9 hydrocarbon resins; cycloaliphatic resins; terpene resins; natural and modified rosins and rosin derivatives; coumarone indenes; polycyclopentadiene and oligomers thereof; polymethylstyrene or oligomers thereof; phenolic resins; indene polymers, oligomers and copolymers; acrylate and methacrylate oligomers, polymers, or copolymers; derivatives thereof; and combinations thereof. Modifying resins may also include alicyclic terpenes, hydrocarbon resins, cycloaliphatic resins, poly-beta-pinene, terpene phenolic resins, and combinations thereof. Useful C5 hydrocarbon resins and C9 hydrocarbon resins are disclosed in U.S. Pat. No. 6,310,154.

The elastically stretchable material may comprise a variety of additives. Suitable additives including, but not limited to, stabilizers, antioxidants, and bacteriostats may be employed to prevent thermal, oxidative, and bio-chemical degradation of the elastically stretchable material. Additives may account for about 0.01% to about 60% of the total weight of the elastically stretchable material. In other embodiments, the composition comprises from about 0.01% to about 25%. In other suitable embodiments, the elastically stretchable material comprises from about 0.01% to about 10% by weight of additives.

The elastically stretchable material may comprise various stabilizers and antioxidants that are well known in the art and include high-molecular-weight hindered phenols (i.e., phenolic compounds with sterically bulky radicals in proximity to the hydroxyl group), multifunctional phenols (i.e., phenolic compounds with sulfur and phosphorous containing groups), phosphates such as tris-(p-nonylphenyl)-phosphite, hindered amines, and combinations thereof. Proprietary commercial stabilizers and/or antioxidants are available under a number of trade names including a variety of Wingstay®, Tinuvin® and Irganox® products.

The elastically stretchable material may comprise various bacteriostats that are known in the art. Examples of suitable bacteriostats include benzoates, phenols, aldehydes, halogen containing compounds, nitrogen compounds, and metal-containing compounds such as mercurials, zinc compounds and tin compounds. A representative example is available under the trade designation Irgasan Pa. from Ciba Specialty Chemical Corporation of Tarrytown, N.Y.

The elastically stretchable material may comprise viscosity modifiers, processing aids, slip agents or anti-block agents. Processing aids include processing oils that are well known in the art and include synthetic and natural oils, naphthenic oils, paraffinic oils, olefin oligomers and low molecular weight polymers, vegetable oils, animal oils, and derivatives of such including hydrogenated versions. Processing oils also may incorporate combinations of such oils. Mineral oil may be used as a processing oil. Viscosity modifiers are also well known in the art. For example, petroleum derived waxes can be used to reduce the viscosity of the slow recovery elastomer in thermal processing. Suitable waxes include low number-average molecular weight (for example 0.6-6.0 kilo Daltons) polyethylene; petroleum waxes such as paraffin wax and microcrystalline wax; atactic polypropylene; synthetic waxes made by polymerizing carbon monoxide and hydrogen such as Fischer-Tropsch wax; and polyolefin waxes.

The elastomeric film 22 also includes at least one skin provided on the elastically stretchable material, the skin forming at least one of the film's surfaces 40, 44. Such skin is a stretchable material and provides an outer surface to the elastomeric film 22 that has less tackiness than the underlying elastically stretchable material. In some embodiments, the skin may also qualify as an elastically stretchable material, but will be less elastic than the underlying elastically stretchable material. Accordingly, when compared to the elastically stretchable material, the skin will have less recovery from the same amount of extension. Or in other words, when compared to the elastically stretchable material, the skin will have a higher percentage set from the same percentage strain. The skin may aid in the processability of the elastomeric film 22 and is between about 1 μm and about 10 μm, or between about 3 μm and about 7 μm, or in some embodiments, is about 5 μm thick. In certain embodiments, the skin that overlays the elastically stretchable material in the elastomeric film 22 is a polyolefin. Nonlimiting examples of useful skin materials include metallocene polyethylene, low density polyethylene, high density polyethylene, linear low density polyethylene, very low density polyethylene, a polypropylene homopolymer, a plastic random poly(propylene/olefin) copolymer, syndiotactic polypropylene, metallocene polypropylene, polybutene, an impact copolymer, a polyolefin wax, and combinations thereof.

Exemplary elastomeric films that are useful in the stretch laminates detailed herein (i.e., an elastically stretchable material with at least one skin provided on the surface of the elastically stretchable material) include M18-1117 and M18-1361 elastomeric films commercially available from Clopay Corporation of Cincinnati, Ohio; K11-815 and CEX-826 elastomeric films commercially available from Tredegar Film Products of Richmond, Va.; and elastomeric films commercially available from Mondi Gronau GmbH of Gronau, Germany. These exemplary elastomeric films include a single layer of elastically stretchable material with a skin provided on both surfaces of the material. Referring to FIG. 1A, such exemplary elastomeric films would have a skin providing first the face 40 and a second skin providing second the face 44. However, other elastomeric films applicable to the stretch laminates detailed herein only need to have a skin that provides first the face 40 or second the face 44.

The cover webs 24 and 26 may include a nonwoven material, including but not limited to, spun only or spun meltblown combinations, such as SM (spunbond meltblown), SMS (spunbond meltblown spunbond), SMMS (spunbond meltblown meltblown spunbond) nonwovens, SSMMS (spunbond spunbond meltblown meltblown spunbound), hydroentangled nonwovens and softbond nonwovens. The nonwoven materials may also include carded nonwovens, such as those specially designed and manufactured to be compatible with an activation (for example ring-rolling) process. One exemplary nonwoven material is a carded nonwoven made from a polypropylene homopolymer. The spunbonds may also be specially designed and/or manufactured to be compatible with an activation process. However, it is believed that through the use of the elastomeric film according to the present disclosure, greater flexibility in the design choices may be achieved. For example, spunbounds may be selected for applications where only carded nonwovens were used in the past, or thinner elastomeric films may be used with the carded nonwovens. Other improvements in design flexibility will also be recognized by the skilled practitioner.

The basis weight of the nonwoven material may be less than about 30 g/m² (also referred to as “grams per square meter” or “gsm”). In fact, according to certain embodiments, the basis weight may be less than about 27 g/m². In other embodiments, the basis weight may be less than about 25 g/m². In still other embodiments, the nonwoven material may have a basis weight of less than about 24 g/m². The nonwoven materials may also include additives, such as, for example, CaCO3. Woven or knitted fabrics may also be used as the cover webs 24 and 26 in embodiments of the stretch laminates detailed herein.

The adhesive 30, 32 may be selected from any adhesives known to provide suitable attachment between the elastomeric film 22 and the cover webs 24 and 26. In some embodiments, the adhesive may be a hot melt adhesive with a basis weight of less than about 15 g/m². According to one embodiment, the adhesive may be H2031 adhesive commercially available from Bostik Inc. of Middleton, Mass. One characteristic of this adhesive is that, at 23° C., this adhesive has significant pressure-sensitive character useful for making a stretch laminate by hand. However, this adhesive is also suitable for use in making stretch laminates from the elastomeric films and cover webs listed above using conventional stretch laminate manufacturing equipment, such equipment being well known in the art.

The elastomeric film 22 is mechanically preactivated before attachment to at least one the cover web 24, 26. The elastomeric film 22 may be preactivated by being stretched transversely to its web direction by more than 50% (i.e., strain >50%). In some embodiments, an expansion by about 100% to about 500% occurs relative to the starting width of the elastomeric film 22. In alternate embodiments, the elastomeric film 22 may be stretched in the web direction, stretched in a direction other than the web direction or transverse to the web direction, or in a combination of directions. The term “stretching” is to point to the fact that the expansion of the elastomeric film 22 is not completely reversible and that a inelastic fraction results in the film having a larger width following preactivation (i.e., the elastomeric film does not have 100% recovery, and therefore has a percent set value). After expansion, the elastomeric film 22 retracts and has a width that may be larger by about 10% to about 30% relative to a starting width of the film. In other words, after the preactivation expansion and retraction detailed below, the elastomeric film 22 may exhibit a set of about 10% to about 30%.

In addition, because the elastomeric film 22 includes both an elastically stretchable material and at least one skin provided on the elastically stretchable material, and because these materials have different elasticity and recovery properties, the preactivation process will physically alter these materials differently. During preactivation, the skin and the elastically stretchable material are similarly stretched (i.e., put under similar strain). However, after stretching, the skin and the elastically stretchable material will retract and recover differently (i.e., have different set values). In comparison with the elastically stretchable material, the skin is less elastic and therefore will have less recovery after stretching, a.k.a., a higher set value. The skin is also much thinner than the elastically stretchable material, so when the thicker elastically stretchable material retracts and recovers after preactivation stretching, it will force the attached skin to retract with it. But because the skin cannot recover as much as the elastically stretchable material, the skin buckles and wrinkles. Accordingly, the cross-sectional profile and the top is view appearance of the elastomeric film 22 are modified after a preactivation process.

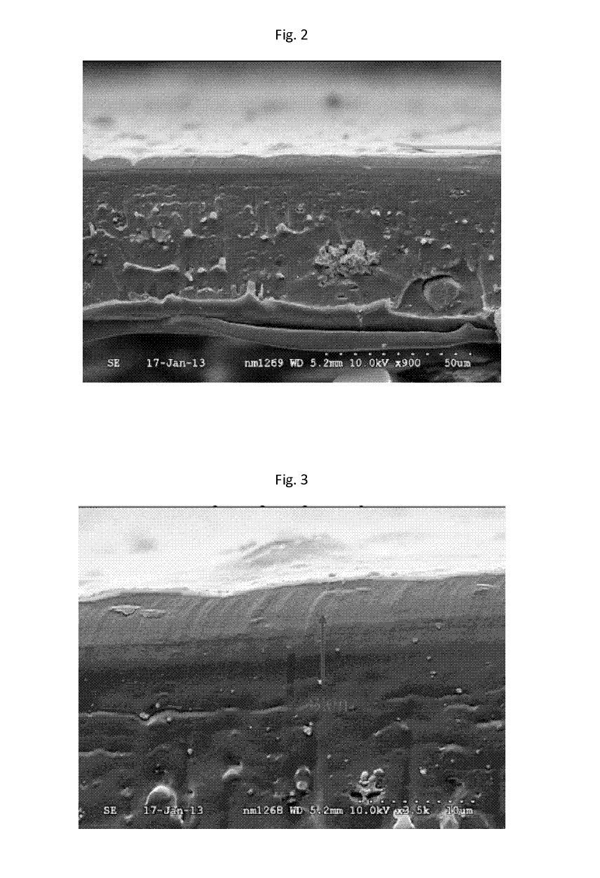

FIGS. 2-5 are SEM photomicrographs of magnified cross-sections of elastomeric films. These SEM photomicrographs, as well as the other SEM photomicrographs included herein, were taken with a scanning electron microscope (Hitachi Model 3500). The information to calculate specific magnifications and distances is included in each individual SEM photomicrograph along the bottom of the frame. FIG. 2 is a SEM photomicrograph taken at approximately 900× magnification showing a cross section through a portion of an elastomeric film that has not been preactivated. The skins are the thin strips of contrasting material at the top and the bottom of the cross-section, with the thicker elastically stretchable material between the skins. The skin at the top of the cross-section is easier to discern due to the cross-section being cut cleaner in that region. Without preactivation, the skins, and thus the outer faces of the elastomeric film, are substantially smooth in a cross-sectional view. FIG. 3 is a higher magnification image (about 3500× magnification) of the skin at the top of the cross section shown in the SEM photomicrograph of FIG. 2

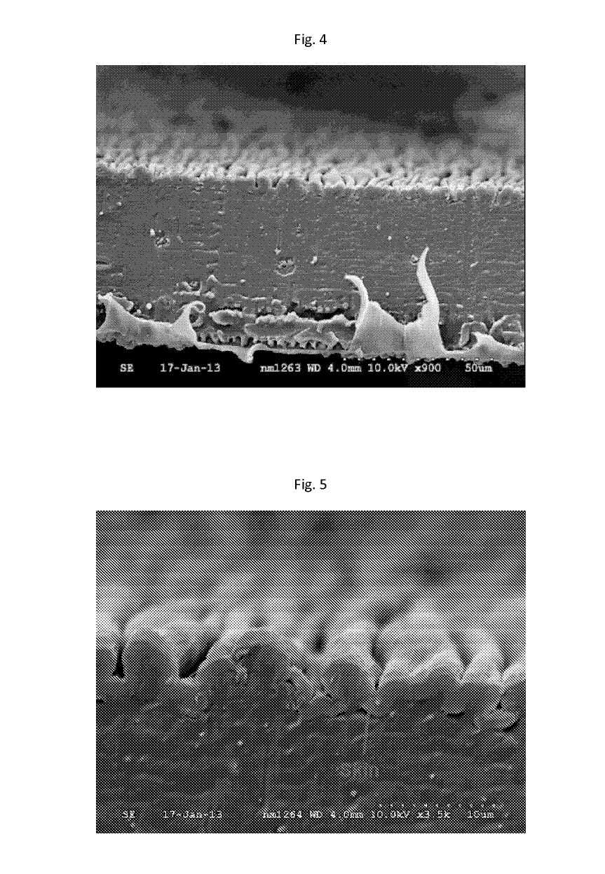

FIG. 4 is a SEM photomicrograph taken at approximately 900× magnification showing a cross section through a portion of an elastomeric film that has been preactivated. Again, the skins are the thin strips of contrasting material at the top and the bottom of the cross-section, with the thicker elastically stretchable material between the skins. With preactivation, the skins, and thus the outer faces of the elastomeric film, are wrinkled in a cross sectional view. FIG. 5 is a higher magnification image (about 3500× magnification) of the skin at the top of the cross-section shown in the SEM photomicrograph of FIG. 4.

FIGS. 4 and 5 show that, after preactivation, the skin of the elastomeric film 22 includes a plurality of wrinkles having hills and furrows. For example, as shown in the nonlimiting sample photographed in FIG. 5, there are approximately six hills and six furrows of varying size within the pictured approximately 35 μm of length taken along the cross-sectional profile of the preactivated elastomeric film. This is in comparison to FIG. 3, in which there are no hills and no furrows within the pictured approximately 35 μm of length taken along the cross-sectional profile of an elastomeric film that was not preactivated. However, as visible on the top face of the elastomeric film shown in FIG. 3, one or more random hills and/or furrows may be present within a particular length of the cross-sectional profile of an elastomeric film that was not preactivated. These random hills and/or furrows are due to irregularities in the face of the elastomeric film. Such random hills and/or furrows should not be confused with the hills and furrows of the plurality of wrinkles that are intentionally formed in an elastomeric film through a mechanical preactivation process.

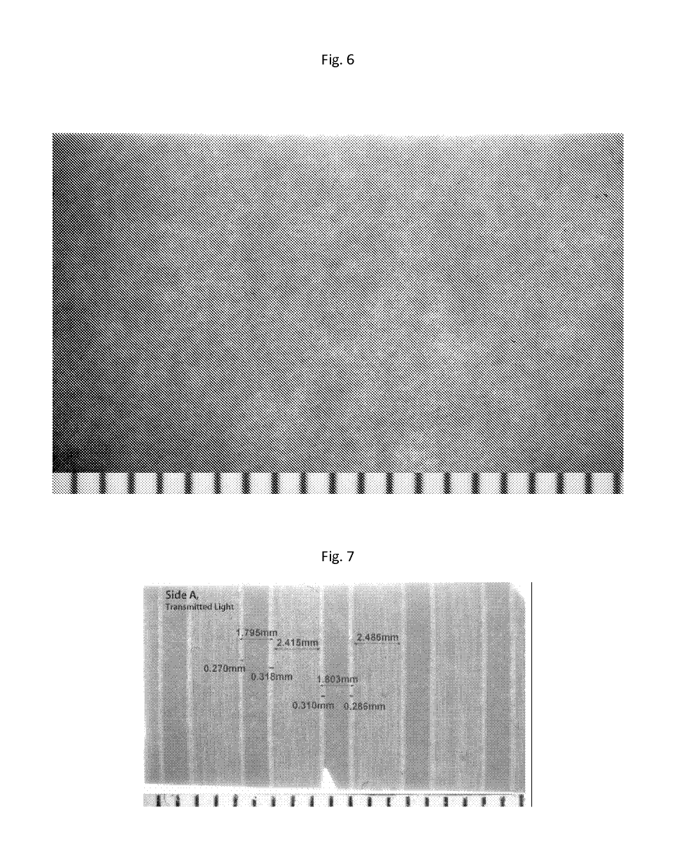

FIGS. 6 and 7 are transmitted light photomicrographs of magnified top views of elastomeric films. The transmitted light photomicrographs were taken in color using a Nikon SMZ 1500 Stereo Light Microscope equipped with an Evolution Mp5C Digital camera with white light shining underneath the elastomeric film samples. The blue scale marks at the bottoms of FIGS. 6 and 7 are in millimeters. This scale can be used to calculate specific magnifications and distances in the transmitted light photomicrographs. FIG. 6 is a transmitted light photomicrograph showing a top view of a portion of an elastomeric film that has not been preactivated. Without preactivation, the viewable outer face of the elastomeric film (i.e., the top view of the skin), has no discernible stripes and is uniform in appearance. FIG. 7 is a transmitted light photomicrograph showing a top view of a portion of an elastomeric film that has been preactivated. With preactivation, the top view of the skin includes a plurality of stripes in varying thicknesses that relate to the size and pitch of the intermeshing discs of the mechanical preactivation means. The stripes, referred to herein as activation stripes, indicate zones in the preactivated elastomeric film in which there was a particular range of stretching during the preactivation process. For example, as shown in nonlimiting sample photographed in FIG. 7, there are medium thickness darker blue stripes indicative of a heavier intensity skin wrinkling, large thickness light blue stripes indicative of medium intensity skin wrinkling, and thin white stripes indicative of lower intensity skin wrinkling.

In addition, after preactivation, but before utilizing the elastomeric film 22 in making the stretch laminate 20, the film may optionally be printed with an image or motif that may show through the cover webs of the stretch laminate. The ink or other pigment utilized in printing will be deposited on the hills and into the furrows of the wrinkles of the preactivated elastomeric film. Ink deposited onto the textured surface of a preactivated elastomeric film allows for more contact surface area between the elastomeric film and the ink. Accordingly, when printing on a preactivated elastomeric film, there is an image that is more strongly set on the film when compared to an image printed on the much smoother face of an elastomeric film that has not been preactivated.

Moreover, when the stretch laminate 20 includes a preactivated (and subsequently printed) elastomeric film that is mechanically activated, a undistorted printed image on the film is evenly and reversibly stretched along with it. This is because before the image was printed on the preactivated elastomeric film, a significant portion or all of the inelastic fraction of the elastomeric film 22 has already been removed in the preactivation process. In other words, the set had been removed from the elastomeric film 22 before printing. Therefore, the printed image will not substantially distort further with the later activation of the stretch laminate 20, or in additional stretching of the laminate by a user. In contrast, if an image or motif were printed on an elastomeric film that was not preactivated, and that printed film was then used in making a stretch laminate, and then the stretch laminate was mechanically activated, the desired image would be distorted in the final activated stretch laminate. This is because the set of the elastomeric film was not removed prior to the printing process, and such set would be removed from the elastomeric film in the mechanical activation of the fabricated stretch laminate, thus distorting the original printed image. Likewise, if an elastomeric film is printed and then subsequently preactivated, the set of the elastomeric film will not be removed prior to the printing process, and such set would be removed from the elastomeric film in the preactivation process, thus distorting the original printed image.

And in another embodiment, a preactivated elastomeric film may be stretched again during the printing of the film. The printed film is then relaxed and used in fabrication and activation of the stretch laminate. The resulting activated stretch laminate has an image or motif that is aesthetically pleasant when the stretch laminate is in a stretched condition during use (for example when a user stretches the stretch laminate in application or removal of an absorbent article).

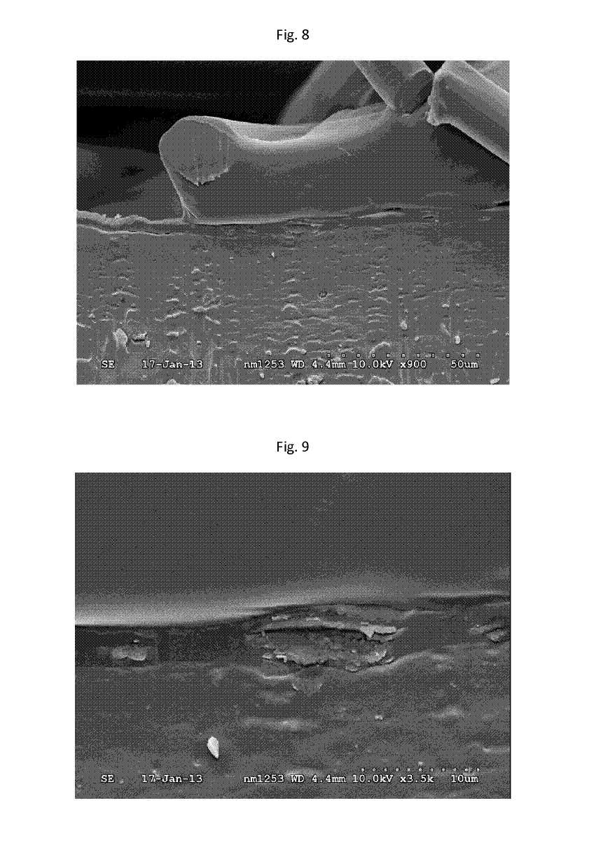

In making the stretch laminate 20, the cover webs 24 and 26 are attached to the elastomeric film 22 by adhesives 30, 32. When utilizing an elastomeric film that has not been preactivated, the adhesive has a relatively smooth surface to which to adhere. FIG. 8 is a SEM photomicrograph taken at approximately 900× magnification showing a cross section through a portion of a stretch laminate that includes an elastomeric film that has not been preactivated. The skin is the thin contrasting strip of material running about midway through the photomicrograph, with the thicker elastically stretchable material underneath the skin. Provided on top of the skin is an adhesive that is also attached to the cover web. In this illustrated embodiment, the fibers of the cover web are the large cylindrical objects at the top of the SEM photomicrograph. Without preactivation, the skins and thus the outer faces of the elastomeric film are substantially smooth in a cross-sectional view. FIG. 9 is a higher magnification image (about 3500× magnification) of the interaction between the skin and glue as shown in the SEM photomicrograph of FIG. 8.

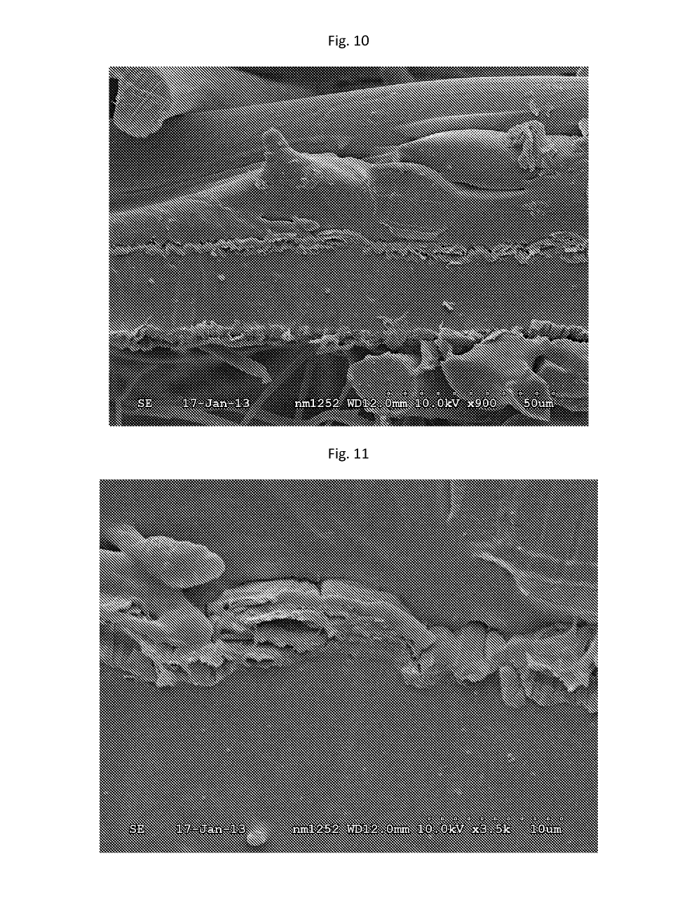

FIG. 10 is a SEM photomicrograph taken at approximately 900× magnification showing a cross section through a portion of a stretch laminate that includes an elastomeric film that has been preactivated. The skins are the contrasting strips of material running through the middle of the photomicrograph, with the thicker elastically stretchable material between the skins. With preactivation, the skins and thus the outer faces of the elastomeric film are wrinkled in a cross sectional view. Provided on outer faces of the skin (i.e., the faces not contacting the elastically stretchable material) is adhesive that is also attached to the cover web. In this illustrated embodiment, the fibers of the cover web are the large cylindrical objects at the top and bottom of the SEM photomicrograph. The preactivated elastomeric film includes a textured skin with wrinkles in a cross-sectional view. FIG. 11 is a higher magnification image (approx. 3500× magnification) of the skin at the top of the elastomeric film shown in the SEM photomicrograph of FIG. 10.

As previously shown in FIGS. 4 and 5, FIGS. 10 and 11 also illustrate that after preactivation, the skin of the elastomeric film 22 is textured and includes a plurality of wrinkles having hills and furrows. The adhesive 30, 32 that attaches the elastomeric film 22 to the cover webs 24 and 26 may flow over the hills and into the furrows of the preactivated elastomeric film. Accordingly, the adhesive 30, 32 is provided in the furrows of the skin of the elastomeric film 22. This is in comparison to FIGS. 8 and 9, in which there are no furrows in the elastomeric film for the adhesive to flow into. Adhesive flowing into the furrows of a preactivated elastomeric film allows for more contact surface area between the film and the adhesive, leading to a stronger bond between the cover web and the film. Accordingly, when using the same amount of adhesive, there is a stronger bond (for example better creep resistance) between a preactivated elastomeric film and a cover web when compared to the bond between an elastomeric film that has not been preactivated and a cover web. Moreover, when employing a preactivated elastomeric film, previous bond strengths between elastomeric films that were not preactivated and a cover web may be achievable with the use of less adhesive.

In embodiments of stretch laminates that include an elastomeric film that is preactivated and subsequently printed, the ink or other pigment utilized in printing will be deposited on the hills and into the furrows of the wrinkles of the film. As detailed above, ink deposited onto the textured surface of a preactivated elastomeric film will more strongly set on the film due to the additional contact surface area between the elastomeric film and the ink (in comparison to ink provided on a elastomeric film that has not been preactivated). The adhesive 30, 32 that attaches the elastomeric film 22 to the cover webs 24 and 26 may also flow over the hills and into the furrows of the preactivated elastomeric film. Accordingly, the adhesive 30, 32 is provided over the ink and/or in the furrows of the skin of preactivated the elastomeric film 22. And because the ink is more strongly set on the preactivated elastomeric film, when using the same amount of adhesive, there is a stronger bond (for example better creep resistance) between a preactivated (and subsequently printed) elastomeric film and a cover web when compared to the bond strength between an printed elastomeric film that has not been preactivated and a cover web. Moreover, when employing a preactivated (and subsequently printed) elastomeric film, previous bond strengths between printed elastomeric films that were not preactivated and a cover web may be achievable with the use of less adhesive.

In addition, preactivating an elastomeric film also lowers the force needed to later stretch the film (versus a inactivated film). This helps the later mechanical activation of the stretch laminate because the load required to activate a stretch laminate that is made with preactivated film will be lower (versus a inactivated film).

The stretch laminate 20 is mechanically activated by stretching the laminate transversely relative to the direction of the web. The technique for forming such a stretch laminate is generally referred to as “zero strain” stretch laminate formation. Examples of zero strain stretch laminate formations and the resulting stretch laminates are described in U.S. Pat. Nos. 4,116,892; 4,834,741; 5,143,679; 5,156,793; 5,167,897; 5,422,172; and 5,518,801. In the particular zero strain stretch laminate formation detailed herein, the stretch laminate 20 may be guided through a nip between two profile rollers, each roller including at least two disk packets each having a plurality of intermeshing disks on a common axis. This process is also commonly referred to as a “ring rolling” process. The stretch laminate 20 is transversely stretched in places by the intermeshing disk packets. The region in which the stretch laminate 20 is stretched by the intermeshing disk packets is referred to as a stretch zone 66. In the roller sections between and/or outside the disk packets, the profile rollers form a gap through which the stretch laminate 20 is guided though essentially without transverse stretching. The regions in which the stretch laminate 20 are not stretched by the intermeshing disk packets are referred to as anchor zones 68, 69. Reference can be made to copending and commonly owned applications attorney's docket 30677 and 30716, which are hereby incorporated by reference.

In the stretch zone 66, the fibers of the cover webs 24 and 26 are modified and irreversibly stretched due to fiber tears and rearrangements. However, because the stretch laminate 20 includes the elastomeric film 22 that has been preactivated, the elastomeric film between the cover webs is not further substantially stretched during the mechanical activation process (i.e., a substantial amount of set is not added to the film during activation of the stretch laminate). In other words, the elastomeric film 22 has substantially the same transverse width before and after mechanical activation of the stretch laminate 20. This is because a significant portion (or the entire) inelastic fraction of the elastomeric film 22 (i.e., the set value) has already been removed in the preactivation process. Accordingly, the expansion properties of the finished stretch laminate 20 is improved in stretch zones 66 in the cross-direction (i.e., transverse to the longitudinal web direction) due to mechanical activation. Following activation, when applying minimal force, the stretch laminate 20 is easily expandable crosswise.

Thus, in the mechanically activated stretch laminate 20 (which is suitable for making an ear panel or other absorbent article part), the elastomeric film 22 is activated in both the stretch zone 66 and in anchor zones 68, 69. In previous stretch laminates that did not include a preactivated elastomeric film, the mechanically activated stretch laminate would include an elastomeric film that was activated in the stretch zone 66, but not activated in the anchor zones 68, 69. Accordingly, the portion of the elastomeric film that was in the anchor zones did not have a plurality of wrinkles. Also, when the viewed from the top, the portion of the elastomeric film that was in the anchor zones did not include a plurality of activation stripes. Further, in previous stretch laminates that did not include a preactivated elastomeric film, the adhesive bonding the elastomeric film to the cover webs was in contact with a unwrinkled surface on the face of the film in both the stretch zone 66 and anchor zones 68, 69 during manufacture. In the stretch laminate 20 described herein, the adhesive 30, 32 that bonds the elastomeric film 22 to the cover webs 24 and 26 is in contact with a textured surface having a plurality of wrinkles on the face of the film in both the stretch zone 66 and the anchor zones 68, 69 during manufacture, providing for increased bond strength between the film and the cover webs.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Specific Description are, in relevant part, incorporated herein by reference; the citation of any document is not to be construed as an admission that it is anticipatory of the present invention. To the extent that any meaning or definition of a term in this disclosure conflicts with any meaning or definition of the term in a document incorporated by reference, the meaning or definition assigned to the term in this disclosure shall govern for this disclosure.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

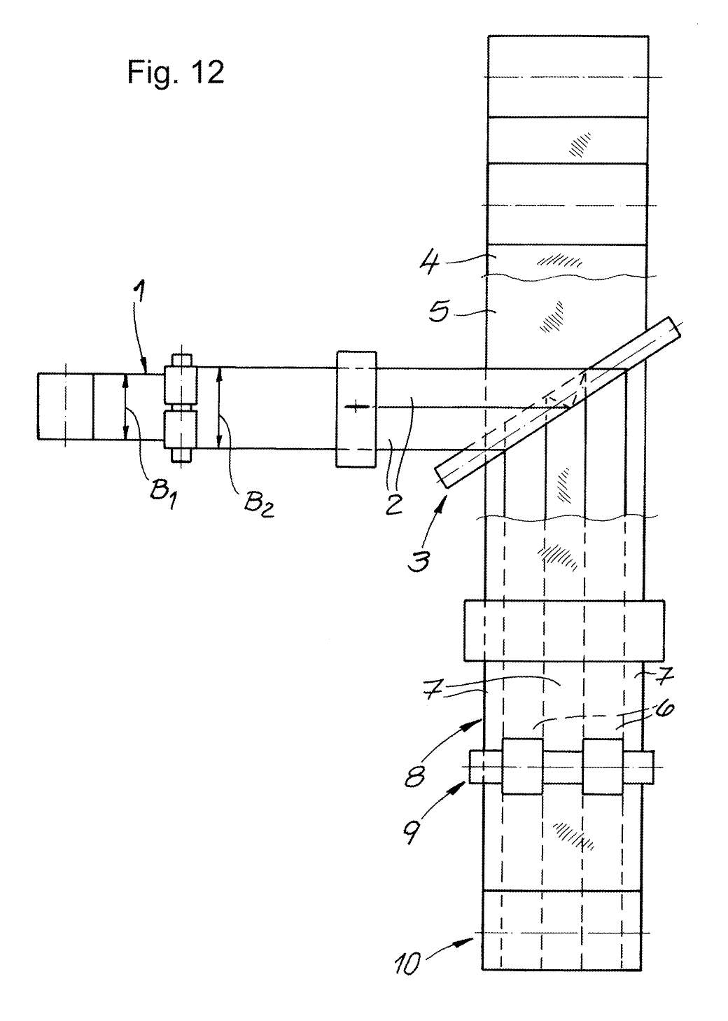

The first embodiment of the method of making a laminate according to the invention is explained below. FIG. 12 schematically shows the method of making an elastic laminate.

In the method shown in the figure, an elastic film 1 is stretched transverse to a web direction in a preactivation station, and after elastic relaxation is cut into strips 2. The strips 2 are guided over deflectors 3, and as parallel strips are laminated next to one another between two nonwoven material webs 4 and 5. The material webs 4 and 5 are guided above and beneath the strips 2 without prestretching, and are adhesively or thermally bonded to the strips 2. The view clearly shows that the elastic strips 2 are laminated at a spacing from one another between the cover webs, and that the nonwoven cover webs 4 and 5 are directly joined together in the gaps between the elastic strips 2. Elastic regions 6 and inelastic regions 7 are thus formed in the laminate 8. The laminate is supplied to an activation unit 9, in which the laminate 8 is stretched transverse to the web direction in the regions 6 rendered elastic by to the laminated strips 2. After elastic relaxation, the laminate 8 is wound into a roll 10.

The elastic film 1 is stretched transverse to the web direction by more than 50% in the preactivation station 11. The stretching occurs essentially uniformly over the entire width of the film 1. The elastic film is preferably stretched by 100% to 300% relative to its starting width of the elastic film, stretching to 500% also being possible. After the elastic relaxation, the elastic film 1 has a width B₂ that is 10% to 30% greater than the starting width B₁ of the elastic film. The stretching of the elastic film 1 constitutes a preactivation that has an advantageous effect on the elongation values of the laminate 8. A stretching roller system composed of intermeshing profile rollers may be used to preactivate the elastic film 1.

A single-layer elastomer film or a multilayer film having an elastomeric core layer composed of styrene-isoprene-styrene block copolymers, styrenebutadiene-styrene block copolymers, styrene-ethylene/butylene-styrene block copolymers, polyurethanes, ethylene copolymers, or polyether block amides may be used as elastic film. An elastic blown film composed of a polyolefin elastomer is particularly preferably used.

The stretching of the laminate 8 is limited to the regions of the laminate 8 that have been made elastic by the laminated and preactivated strips 2. For this purpose, the laminate 8 is guided through a nip between two profile rollers that include at least two packets of a plurality of disks mounted on an axle. The laminate is stretched in places by the intermeshing disk packets of the two profile rollers. As a result of the stretching, textile structures of the cover webs are altered in the elastic regions 6 of the laminate, and the elongation properties of the laminate 8 in the CD direction, i.e. transverse to the web longitudinal direction, are improved. Relative to the overall width of the laminated strips 2, the maximum transverse stretching of the laminate during stretching corresponds to the value by which the elastic film 1 is stretched during preactivation. The transverse stretching of the laminate 8 relative to the overall width of the laminated strips is preferably 50% to 90% of the value by which the elastic film 1 is stretched during preactivation. Next to the disk packets, the profiles have roller sections in which the laminate is not subjected to transverse stretching. These sections define a nip through which the laminate 8 is guided essentially without transverse stretching.

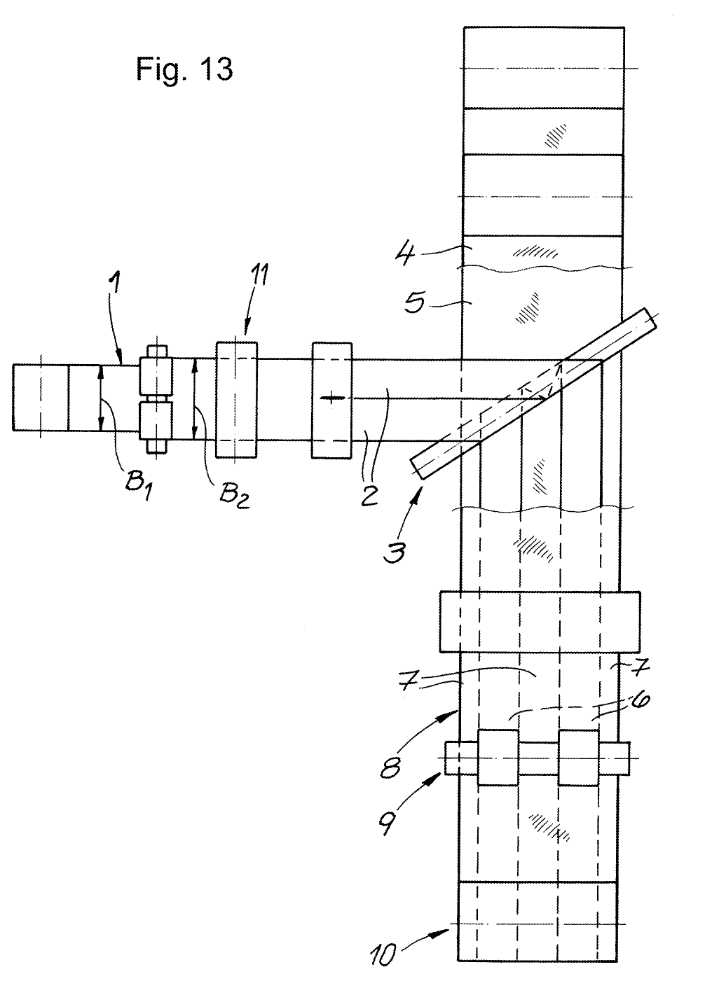

The second embodiment of the method will be illustrated in further detail with reference to a similar illustrated embodiment. FIG. 13 is a schematic representation of the second method of making a printed, elastic laminate.

With the method shown in the FIG. an elastic film 1 is cut into strips 2 that are guided across a deflector 3 and supplied to a laminator 4 as parallel strips. The strips 2 are laminated in the laminator 4 between textile cover webs 5 and 6 that are fed from above and below to the strips 2. The strips 2 and the textile cover webs 5 and 6 are glued together or connected to each other thermally. The view in the figure shows that the elastic strips 2 are laminated at a spacing from each other between the cover webs 5 and 6 and that the textile cover webs 5 and 6 are directly connected to each other in gaps between the elastic strips 2. This way, elastic regions 8 and 10 as well as inelastic regions 9 are created in the laminate 7. The laminate is then supplied to an activator 10 in which the laminate 7 is stretched transversely at the regions 8 rendered elastic by the laminated strips 2 relative to the direction of the web. A stretch-roller apparatus having profile rollers that mesh with each other is used for stretching the laminate 7. Stretching modifies the textile structures of the cover webs, and the expansion property of the laminate 7 is improved in the CD direction, that is transverse of the longitudinal web direction. Following activation, the laminate is easily expandable in the CD direction by minimal force to an expansion limit that is determined by the activation.

The textile cover webs 5 and 6 are made of, in particular, nonwoven fabric; woven or knitted fabrics are also possible. A single-layer or multilayer elastomer film can be used as elastic film 1 having an elastomer core layer made of styrene-isoprene-styrene block copolymers, styrene-butadiene-styrene block copolymers, styrene-ethylene-butylene-styrene block copolymers, polyurethanes, ethylene copolymers, or polyether block amides. An elastic blown film made of a polyolefin elastomer is preferred.

Before cutting the film into strips 2, the elastic film 1 is printed in a printing station 11 with a motif that is visible through the textile surface layer 5 and 6 of the laminate 7. Printing is preferably done by a rotary printing method, particularly flexography. The printed motif can be, for example, a striped motif made of parallel colored stripes that extend in the longitudinal direction of the elastic film of the web.

Before printing, the elastic film 1 is stretched transversely of the web by more than 50%. Preferably, an expansion by 100% to 500% is effected relative to a starting width of the elastic film. After the elastic retraction, the elastic film 1 has a width B₂ that is larger by 10% to 30% than a starting width B₁ of the elastic film. Following the retraction, the elastic film 1 is printed and subsequently cut into strips 2. Expanding and/or stretching the elastic film 1 constitutes preactivation. Preactivation of the elastic film has considerable advantages with regard to the expansion values of the laminate 7. Due to preactivation of the elastic film 1 prior to the printing process, it is also possible to improve the printed image of the elastic laminate 7, the reason for this being that during stretching of the laminate 7, the printed image is evenly and reversibly expanded along with the laminate, and preactivation of the elastic film 1 results in the laminate 7 completely resetting itself following stretching in the activation apparatus 10.

We claim:

1. A stretch laminate comprising:
at least one cover web;
an elastomeric film attached to the cover web and having two opposite faces;
a skin on at least one of the faces; and
an adhesive at an anchor zone between the skin and the cover web bonding the skin to the cover web at the anchor zone, leaving a stretch zone free of adhesive adjacent the anchor zone, the skin having wrinkles in the anchor zone and not in the stretch zone.

2. The stretch laminate defined in claim 1, wherein the wrinkles are substantially perpendicular to a stretch direction of the stretch laminate.

3. The stretch laminate defined in claim 1, wherein the elastomeric film is preactivated.

4. The stretch laminate defined in claim 1, wherein the wrinkles are separated by furrows at least some of which are provided with the adhesive.

5. The stretch laminate defined in claim 1, wherein the adhesive engages the elastomeric film underneath the skin at least in places.

6. The stretch laminate defined in claim 1, wherein the elastomeric film is a polyolefin elastomer.

7. The stretch laminate defined in claim 1, wherein the elastomeric film is a blown film.

8. The stretch laminate defined in claim 1, wherein the elastomeric film is 20 μm to 60 μm thick.

9. The stretch laminate defined in claim 1, wherein the elastomeric film is about 40 μm thick.

10. The stretch laminate defined in claim 1, wherein the skin is 1 μm to 10 μm thick.

11. The stretch laminate defined in claim 1, wherein the wrinkles have hills, the laminate further comprising:
ink on at least some of the hills.

12. The stretch laminate defined in claim 1, wherein the wrinkles have furrows, the laminate further comprising:
an ink in at least some of the furrows.

13. The stretch laminate defined in claim 12, wherein at least some of the ink is covered by the adhesive such that at least some of the ink is provided between the skin and the adhesive.

14. The stretch laminate defined in claim 13, wherein the ink touches the elastomeric film underneath the skin at least in places.
